(19) United States
(12) Patent Application Publication
(10) Pub. No.: US 2023/0009777 A1
(43) Pub. Date: Jan. 12, 2023

(54) METHOD AND COMPUTER PROGRAM PRODUCT FOR THE MAINTENANCE OF COMMERCIAL AIRCRAFT

(71) Applicant: Lufthansa Technik AG, Hamburg (DE)

(72) Inventors: Dajana Kunz, Ulm (DE); Valerie Hermann, Bensheim (DE)

(21) Appl. No.: 17/779,559

(22) PCT Filed: Nov. 25, 2020
(86) PCT No.: PCT/EP2020/083285

§ 371 Date: May 25, 2022

(30) Foreign Application Priority Data
Nov. 26, 2019 (DE) 10 2019 132 018.6

(51) Int. Cl. G06Q 10/00; G08G 5/00; G06Q 10/10

(52) U.S. Cl. CPC G06Q 10/20; G08G 5/0039; G06Q 10/1097

(57) ABSTRACT

A method schedules maintenance on aircraft of a fleet. The method includes: determining the required items of maintenance of an aircraft, including deadlines; if the deadline of the maintenance is within the first period of time: specifying a maintenance station adequately equipped for carrying out the maintenance work in the flight network for carrying out the maintenance work in a specific ground time of the aircraft; if that deadline is in the second period of time: specifying a time span required for carrying out the maintenance within the second period of time, and specifying the routing of all aircraft in the flight network in consideration of the technical data of the aircraft and the technical requirements of the individual flight routes. and carrying the maintenance work at the specified maintenance station in the provided ground time.

### CROSS REFERENCE TO RELATED APPLICATIONS

This application is a U.S. National Phase application under 35 U.S.C. § 371 of International Application No. PCT/EP2020/083285, filed on Nov. 25, 2020, and claims benefit to German Patent Application No. DE 10 2019 132 018.6, filed on Nov. 26, 2019. The International Application was published in German on Jun. 3, 2021 as WO 2021/105161 A1 under PCT Article 21(2).

### FIELD

The present disclosure relates to a method for the maintenance of commercial aircraft and a corresponding computer program product.

### BACKGROUND

Commercial aircraft used in a flight network have to be maintained regularly to ensure safe operation. In addition to maintenance work, which is to be carried out on the basis of producer specifications according to fixed maintenance intervals, corrective measures also have to be carried out for error messages output from the onboard computer of the aircraft.

The corresponding work has to be carried out on the ground at maintenance stations configured for this purpose and equipped with corresponding personnel, wherein maintenance stations are generally only provided at selected points of a flight network, and additionally each have individual equipment. In other words, not every maintenance station is equipped for all possibly arising repair measures.

During maintenance, the aircraft is necessarily on the ground. In particular with regard to the items of maintenance work according to the fixed maintenance intervals, ground times at an airport having maintenance stations are provided in the usage planning of an aircraft in a flight network in order to be able to carry out the corresponding items of maintenance work that can be planned. The planning, in particular the personnel planning, of the maintenance stations has to be adapted accordingly to these ground times.

The ground times provided for the regular maintenance, and also other downtimes of an aircraft, for example, overnight, can be planned with a certain buffer to also be able to remedy unpredicted errors on the aircraft. Corresponding errors are recognized and detected during the operation of an aircraft by its onboard computer.

The planning of the items of maintenance work of all aircraft of a fleet at the maintenance stations available in the flight network often takes place manually, possibly solely with the aid of computer tools for the graphic representation of the work to be carried out and the utilization of the maintenance stations, or for the detailed planning of complex items of maintenance work of a single aircraft, which require multiple maintenance teams and/or a complex step sequence.

The planning of the items of maintenance work is continuously subject to change, in particular due to changes at short notice or disturbances in the flight operation. Not only the time shift of ground times in relation to aircraft to be maintained plays a role, but in principle also any change of the use of a specific aircraft. This is because the maintenance intervals decisive for the planning of the regular items of maintenance work are generally based on the actual flight hours and/or the number of the flight cycles, which can decisively change in the event of an unpredicted change of the flight plan or the use of an aircraft therein in such a way that a maintenance has to take place at an earlier point in time than originally provided. In addition, a change of the flight plan or the use of an aircraft therein can have the result that an aircraft is located, at a ground time provided for the maintenance, at a different maintenance station than the originally provided maintenance station.

Such changes at short notice can exclusively be taken into consideration manually in the maintenance planning—and generally with time pressure. The result of the maintenance planning is often not optimal in this case. In addition, sometimes significant overcapacities are to be kept ready at certain maintenance stations to be able to meet increased maintenance demand possibly occurring at short notice such that if possible no disturbance of the flight plan occurs due to maintenance which is not completed in a timely manner.

### SUMMARY

In an embodiment, the present disclosure provides a method that assists with the carrying out items of maintenance work on commercial aircraft of a fleet used in a flight network. In the method, the following information is available: for each of the aircraft of the fleet: technical data, information on required items of maintenance work on the basis of maintenance intervals or error messages having deadlines for the completion of the individual items of maintenance work, and items of information on the provided routing of the aircraft in the flight network in a first period of time having the ground times of the aircraft; for the fleet: a flight plan for a second period of time following the first period of time, including the flight routes of the flight network to be operated having the technical requirements of the individual flight routes; and for the flight network: the maintenance stations in the flight network including their technical equipment and capacity. The method includes: determining the required items of maintenance work of at least one aircraft of the fleet, the required items including the deadlines of the items of maintenance work; upon determining that the deadline of at least one item of maintenance work of an aircraft falls in the first period of time: specifying a maintenance station adequately equipped for carrying out the maintenance work in the flight network for carrying out the maintenance work in a specific ground time of the aircraft; upon determining that the deadline of an item of maintenance work of an aircraft falls in the second period of time: specifying at least one time span required for carrying out the item(s) of maintenance work on an aircraft within the second period of time, and specifying the routing of all aircraft in the flight network in consideration of the technical data of the aircraft and the technical requirements of the individual flight routes, wherein the routing for the aircraft to be maintained has a ground time corresponding to the at least one specified time span at a maintenance station adequately equipped for carrying out the maintenance work; and carrying out the items of maintenance work on an aircraft at the specified maintenance station in the provided ground time.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a method according to an aspect of the present disclosure;

FIG. 2 is another schematic illustration of the method according to an aspect of the present disclosure;

FIG. 3a is another schematic illustration of the method according to an aspect of the present disclosure; and

FIG. 3b is another schematic illustration of the method according to an aspect of the present disclosure;

### DETAILED DESCRIPTION

Aspects of the present disclosure provide improvements over the prior art for the maintenance of commercial aircraft and a corresponding computer program product.

An aspect of the present disclosure accordingly relates to a method for carrying out items of maintenance work on commercial aircraft of a fleet used in a flight network, wherein:
for each aircraft of the fleet:
   technical data,
   items of information on required items of maintenance work on the basis of maintenance intervals and/or error messages comprising deadlines for the completion of the individual items of maintenance work, and
   items of information on the provided routing of the aircraft in the flight network in a first period of time comprising the ground times of the aircraft;
for the fleet:
   a flight plan for a second period of time following the first period of time comprising the flight routes of the flight network to be operated having the technical requirements of the individual flight routes; and
for the flight network:
   the maintenance stations in the flight network comprising their technical equipment and capacity;
      are available. The method has the following steps:
determining the required items of maintenance work of at least one aircraft comprising the deadlines of the items of maintenance work;
if the deadline of at least one item of maintenance work of an aircraft falls in the first period of time:
   specifying a maintenance station adequately equipped for carrying out the maintenance work in the flight network for carrying out the maintenance work in
   a specific ground time of the aircraft;
if the deadline of an item of maintenance work of an aircraft falls in the second period of time:
   specifying at least one time span within the second period of time required for carrying out the item(s) of maintenance work on an aircraft, and
   specifying the routing of all aircraft in the flight network in consideration of the technical data of the aircraft and the technical requirements of the individual flight routes, wherein the routing for the aircraft to be maintained has a ground time corresponding to the at least one fixed time span at a maintenance station adequately equipped for carrying out the maintenance work; and
carrying out the items of maintenance work on an aircraft at the specified maintenance station in the provided ground time.

Furthermore, an aspect of the present disclosure relates to a computer program product comprising program parts which, when loaded in a computer, are designed to carry out the method according to aspects of the present disclosure.

Firstly, several terms used in conjunction with the present disclosure will be explained.

A “deadline” for the completion of the individual items of maintenance work denotes that point in time at which an item of maintenance work on the basis of maintenance intervals or on the basis of an error message has to be completed at the latest. The requirement results here either from producer or authorization guidelines, which can relate in particular to the flight safety, or to other guidelines, for example, the functioning of conveniences for the passengers, for example, the onboard entertainment system. The “deadline” can be specified here as a calendar date or in the form of flight hours or flight cycles. Thus, for example, for specified maintenance intervals or for specific error messages, it can be specified within how many flight hours of the aircraft the corresponding maintenance work is to be carried out.

The use of commercial aircraft in a flight network takes place according to a flight plan, which is based on the so-called “routing” of the aircraft. While the flight plan solely specifies which connection between two airports of the flight network is to be operated at which time (“flight route”) by a (fundamentally arbitrary, technically suitable) aircraft, it is specified in the routing of an aircraft which of the flight routes according to the flight plan this specific aircraft is to operate in succession.

The method according to an aspect of the present disclosure is distinguished in that if an item of maintenance work arises—independently of whether this arises due to a specified maintenance interval or an occurring error message—a specification of the required maintenance work takes place on the basis of diverse items of technical information, which as much as possible has no or only minor negative effects on the operation of the flight network.

To carry out the method, according to an aspect of the present disclosure, diverse technical variables of the flight network including maintenance stations, the fleet of aircraft used on the flight network, and the individual aircraft are used.

Diverse technical data thus are provided for the individual aircraft. The required technical data can be those which are required for creating a flight plan. In addition to the specification of the payload mass or—more relevantly in commercial aircraft—the passenger capacity, possibly divided into individual booking classes, data relating to the range, cruise speed, and/or takeoff and landing requirements can be included therein. These technical data can be used, for example, to ensure during the creation of the flight plan that an aircraft can also actually operate a specific flight route with respect to its requirements such as passenger volume, length, and takeoff and landing conditions in the desired flight time. For the items of maintenance work possibly to be carried out, data of the aircraft are preferably known, which depict the type of the aircraft and the diverse options provided in the aircraft, for example, jet engine options, interior fittings, etc.

The items of information on the required items of maintenance work can comprise still further items of technical information in addition to the deadlines for the completion of the individual items of maintenance work (which can themselves be considered items of technical information). In particular, the items of technical information can relate to the components of the aircraft affected by the maintenance work and/or to possible requirements for which aircraft systems are possibly to be temporarily shut down for the maintenance work. These items of information can be used to coordinate various items of maintenance work to be executed. If the electrical system of the aircraft is temporarily to be deactivated completely for a required item of maintenance, for example, no items of maintenance work can be carried out simultaneously which require a continuous power supply, for example, the update of computer systems. Vice versa, it can also result from the technical data which items of maintenance work may possibly be executed in parallel.

For the technical requirements of the individual flight routes of the flight network, the above-mentioned takeoff and landing parameters of the airports of the flight network thus connected and the distance between the airports can be provided to be able to ensure that an aircraft provided for a specific flight route can also actually take off or land at the airports connected thereby and can cover the distance between the airports without problems. The items of technical information in question can in this case comprise the length and/or the permissible surface pressure per landing gear wheel of the takeoff and/or landing runways of the airports, and possibly their altitude above sea level.

The technical data about the individual maintenance stations in the flight network primarily relate to the technical equipment of the maintenance stations with regard to the items of maintenance work which can be carried out there and the aircraft types which can be maintained. The maintenance stations can be arranged at airports directly considered in the flight plan. However, it is also possible that a maintenance station is arranged at an airport which is not directly included by the flight routes of the flight plan, but is only stopped at by the aircraft for maintenance purposes.

For the individual items of maintenance work, a time span is specified—possibly separately for each maintenance station—which is to be budgeted for a specific item of maintenance work. This time span fundamentally results from the technical requirements of the maintenance work and can be determined in particular from recordings of past items of maintenance.

The routing of the individual aircraft of a fleet is generally created a few days in advance on the basis of the flight plan provided for these days, i.e., it is specified which aircraft is to operate which flight routes of the flight plan. In addition to the fundamental technical suitability of an aircraft to be able to actually operate a specific flight route (for example with respect to passenger capacity and range) as well as possible turnaround times at the individual airports, in principle ground times required for items of maintenance work—if known—at specific maintenance stations in the flight network can also be taken into consideration. Of course, aircraft which are known to have to require complex maintenance over the entire planning period of time for the routing are also not taken into consideration in the determination of the routing until the completion of the maintenance work.

The planning period of time for the routing is preferably less than 21 days, generally 3 to 7 days. The period of time for which the routing exists for the individual aircraft of a fleet is the first period of time according to an aspect of the present disclosure.

This first period of time is followed by the second period of time, for which the flight plan does already exist—thus which routes are to be operated at which times—but it is not yet specified which aircraft is actually to operate the individual flight routes in each case.

Based thereon, an aspect of the present disclosure is based on the finding that the different planning status relating to the use of aircraft of a fleet in a flight network in the first and the second period of time can advantageously be used for carrying out items of maintenance work or their specification.

Items of maintenance work, the deadline of which falls in the first period of time and which are thus to be handled within the already created routing of an aircraft, are budgeted in the ground times of the aircraft predetermined in the routing at maintenance stations technically suitable for the required items of maintenance work. In the case of items of maintenance work already predictable on the basis of predetermined maintenance intervals, these can be taken into consideration directly in the routing—inter alia, by the present method (see below). For items of maintenance work arising due to error messages, an assignment at short notice of a ground time of the aircraft to a maintenance station takes place, which is equipped technically adequately for carrying out at least that part of the required items of maintenance work, the deadline of which does not permit later maintenance at another maintenance station. The ground time of the aircraft to be maintained, in which the items of maintenance work are to be carried out, is also specified.

In addition to the adequate technical equipment of the maintenance station, the utilization of the maintenance station at the ground time of the aircraft in question can also be taken into consideration in the specification of the maintenance station. If multiple maintenance stations come into consideration in principle on the basis of the routing specified for the aircraft—thus if multiple ground times at different airports having technically suitable maintenance stations are provided by the deadline of the required items of maintenance work—that maintenance station can be selected, the capacities of which are sufficient for the items of maintenance work in question. For this purpose, items of information about the items of maintenance work planned at a maintenance station are collected on all aircraft comprising the ground time provided for this purpose and taken into consideration in the selection of the maintenance station.

If sufficient capacity for an assignment of an aircraft at short notice on the basis of an error message within the associated deadline is not free at any of the maintenance stations fundamentally coming into consideration, it is preferred if, at the maintenance stations in question, items of maintenance work which are not urgently required or are deferrable on the basis of the respective deadline are deferred to other aircraft (for example to a later ground time, possibly also at another maintenance station), to thus provide capacities for the items of maintenance work of an aircraft urgently required at short notice.

In particular upon the assignment of an aircraft at short notice to a maintenance station due to an error message, it is also possible, with sufficient capacity of the maintenance station, to possibly specify already known items of maintenance work, which are not yet scheduled (for example because the deadline is still far in the future) together with the items of maintenance work to be carried out due to an error message at the maintenance station and subsequently to carry them out accordingly. Of course, this is always only possible if the maintenance station is also adequately technically equipped for these additional items of maintenance work and has sufficient capacity. In general, only those additional items of maintenance work are budgeted which may be handled within the provided ground time. It is thus ensured that the routing of the aircraft to be maintained does not have to be changed. A further ground time of the aircraft at a maintenance station can thus be avoided at least in some cases.

The correspondingly specified additional items of maintenance work are again generally those which can be deferred if needed in the case of an urgently required maintenance at short notice of another aircraft (see above).

With the above-described specification of items of maintenance within the first period of time, thus in particular items of maintenance work becoming necessary at short notice due to error messages, the method according to an aspect of the present disclosure has the result that in general neither the routing nor the flight plan has to be changed for the first period of time. It has been shown that this may be achieved with the aid of the method according to the invention at least if no capital damage occurs on the aircraft, which requires, for example, an immediate shutdown of an aircraft.

If items of maintenance work are due, the deadlines of which fall in the second period of time, it is provided in the method according to an aspect of the present disclosure that the ground times required for this purpose be taken into consideration directly during the routing of the individual aircraft of a fleet—thus the assignment of the aircraft to specific flight routes in the flight plan. Such items of maintenance work can primarily be items of maintenance work predetermined by maintenance intervals, for which often a greater span is provided from when a specific item of maintenance work is to be started at the earliest and/or when it is to be completed at the latest. In the scope of the present disclosure, an item of maintenance work is “required” at the former point in time, while the latter point in time represents the deadline for an item of maintenance work. Of course, it is also possible that the deadline of an item of maintenance work which has become necessary due to an error message falls in the second period of time.

For each of the required items of maintenance work, items of information are preferably provided on their duration to be expected, the technical requirements on a maintenance station suitable for carrying out the maintenance work, and possibly items of information about which other maintenance work can be carried out in parallel thereto on the same aircraft. On the basis of these items of information for individual items of maintenance work or groups of items of maintenance work which can be carried out in parallel, one or more time spans can be determined which comprise the required ground times for carrying out one or more items of maintenance work and the technical requirements for a maintenance station suitable for carrying out the item(s) of maintenance work.

The time spans thus preferably specified for all aircraft of a fleet are taken into consideration in routings of all aircraft in the flight network. In addition to the consideration known from the prior art of the technical data of the aircraft and the technical requirements of the individual flight routes, in addition ground times at maintenance stations corresponding to the previously determined time spans are provided for the individual aircraft, i.e., the ground times are greater than or equal to the determined time span and additionally are also provided at maintenance stations, the technical equipment of which is sufficient for the items of maintenance work to be carried out in a time span. As a result, it is ensured that all items of maintenance work arising in the phase for which the routing of the individual aircraft is created can be carried out properly at provided ground times and at respectively suitable maintenance stations. The routing thus created becomes with progressing time, as soon as the second period of time is reached, the routing of the aircraft in the aircraft network in the first period of time (see above).

During the creation of the routing and in particular the provision of the ground times required for the items of maintenance work, in addition to the comparison of the technical requirements, an optimization also takes place with respect to the utilization of the individual maintenance stations in the flight network. It is not only ensured that more items of maintenance work are not to be carried out in parallel than the capacity of the maintenance station permits at any of the maintenance stations, wherein capacity relates in this context not only to the technical equipment of the maintenance station, but also to the availability of maintenance personnel at this station. By evening out the utilization, it is ensured that maintenance personnel are utilized evenly. At the same time, it is ensured that in general capacities for carrying out items of maintenance work required at short notice due to error messages are generally available at each of the maintenance stations on aircraft not budgeted for the maintenance (see above).

The creation of the routing for the second period of time can preferably initially build on the routing from the first period of time. For this purpose, it is preferably checked whether upon updating the flight plan from the first period of time, it is possible to carry out the maintenance work at an adequately equipped maintenance station at a planned ground time and, if so, the routing of all aircraft in the flight network is updated for the second period of time until the deadline of the maintenance work from the first period of time. If the updating of the flight plan from the first period of time is possible in principle, the otherwise required computing power for creating an alternative routing can be omitted.

Alternatively or additionally, it is also possible that individual flight routes are combined to form a “rotation”, in which the flight routes are flown by one aircraft after another in succession to one another. The rotations can begin and end at the same airport or at two different airports. By specifying rotations instead of the flight routes combined therein, the computing power for creating a routing of all aircraft in the flight network can generally be reduced for the second period of time.

Independently of whether specified in the context of the first or second period of time, the planned items of maintenance work will be carried out in the ground time provided for them at the maintenance station provided for them according to the prior art.

As described, the method according to an aspect of the present disclosure is also based, when specifying ground times of an aircraft at specific maintenance stations both for the first and also for the second period of time, on a plurality of technical parameters which are to be taken into consideration. As a result, not only the items of maintenance work due are carried out before reaching the respectively provided deadlines, but rather at the same time the flight plan, in which the various flight routes mesh, is not disturbed or is at least only hardly disturbed. The steps and comparisons required for this purpose cannot be managed manually or at least cannot be managed manually in an acceptable time due to the high complexity.

In addition to the required items of maintenance work on the basis of maintenance intervals or error messages, items of maintenance work can also be taken into consideration in the method according to an aspect of the present disclosure which result when carrying out other items of maintenance work or the requirement for which is discovered at this time (so-called “findings”). It is also possible to take into consideration items of maintenance work considered to be necessary due to predictive maintenance in the method according to an aspect of the present disclosure.

Reference is made to the above statements for the explanation of the computer program product according to an aspect of the present disclosure. It ultimately, carrying out the items of maintenance work generally cannot be carried out by the computer program product itself, but rather the method steps which can be depicted by the computer program product only extend up to ultimately carrying out the items of maintenance work.

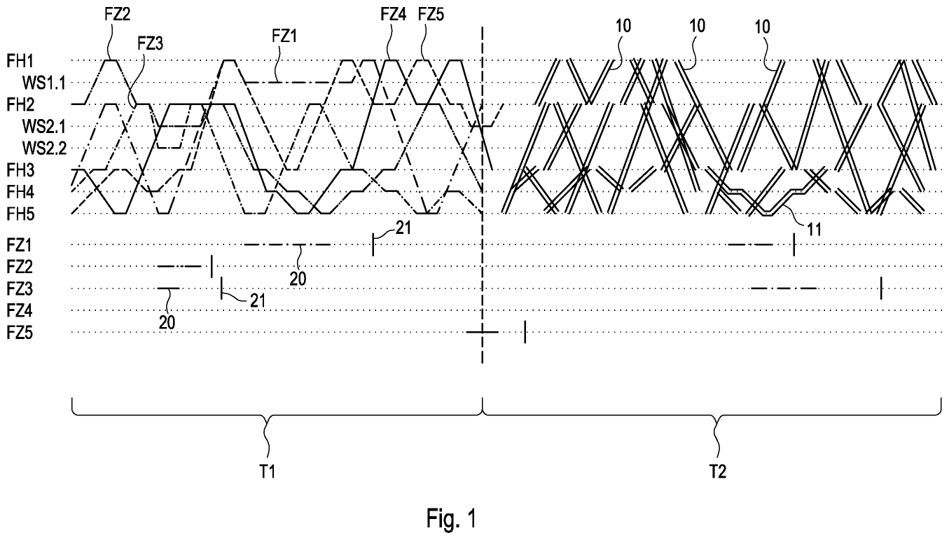

As the starting point for the further explanations of the method according to an aspect of the present disclosure, in the upper region of FIG. 1, for five aircraft FZ1, FZ2, FZ3, FZ4, FZ5 of a fleet, the respective routing in a flight network comprising five airports FH1, FH2, FH3, FH4, FH5, of which two airports FH1, FH2 have maintenance stations WS1.1, WS2.1, WS2.2, is shown within a first period of time T1 in the course of time from left to right. The possible layover positions of an aircraft FZ1, FZ2, FZ3, FZ4, FZ5 at an airport FH1, FH2, FH3, FH4, FH5 or at a maintenance station WS1.1, WS2.1, WS2.2 are each shown by a horizontal dotted line. It is specified by the individual lines for the aircraft FZ1, FZ2, FZ3, FZ4, FZ5 when which aircraft FZ1, FZ2, FZ3, FZ4, FZ5 is either located at a layover position FH1, FH2, FH3, FH4, FH5, WS1.1, WS2.1, WS2.2 (cf. horizontal sections), or when it is located on the path between layover positions FH1, FH2, FH3, FH4, FH5, WS1.1, WS2.1, WS2.2 (cf. diagonal sections), whether it is on a flight between two airports FH1, FH2, FH3, FH4, FH5 or the taxiing to or from a maintenance station WS1.1, WS2.1, WS2.2. The ground times of the individual aircraft FH1, FH2, FH3, FH4, FH5 at the individual airports FH1, FH2, FH3, FH4, FH5 may thus be read directly from FIG. 1.

In the lower region of FIG. 1, for each of the five aircraft FZ1, FZ2, FZ3, FZ4, FZ5 of the fleet, the items of information about required items of maintenance 20 according to predetermined maintenance intervals are shown over time, wherein each of the items of maintenance 20 may be delayed in time if needed until the respectively indicated deadline 21.

The routing of the aircraft FZ1, FZ2, FZ3, FZ4, FZ5 is selected in the first period of time T1 so that all flight routes of a flight plan are operated.

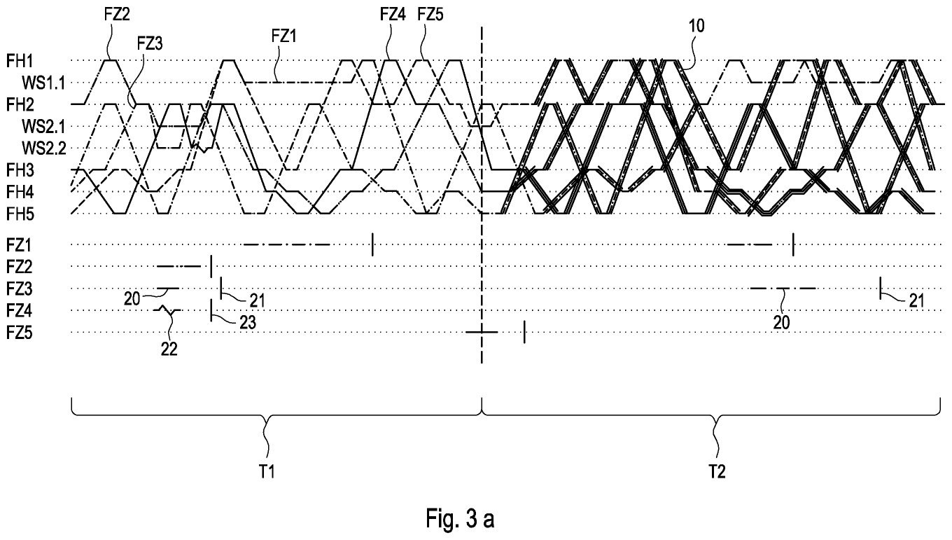

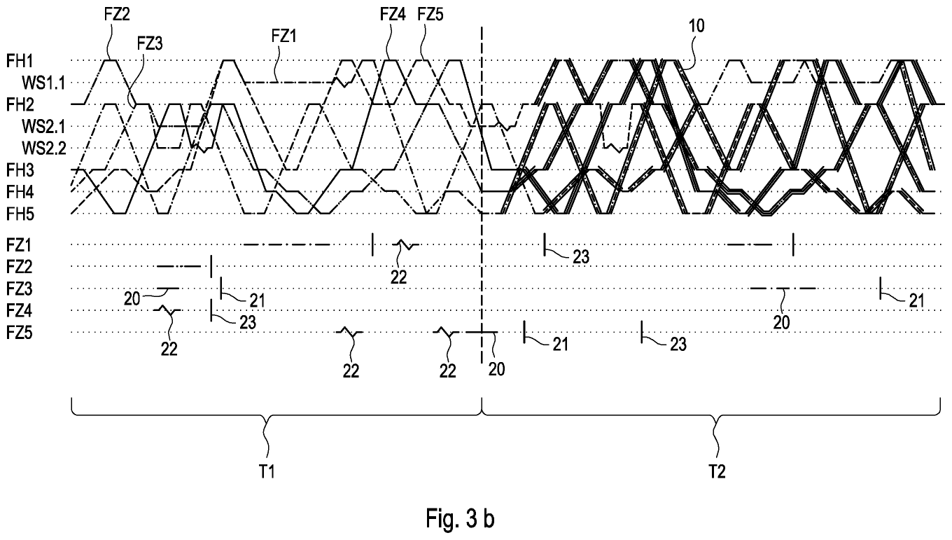

As will be explained later in more detail on the basis of FIGS. 3a and b, at the same time the routing is planned by the method according to an aspect of the present disclosure so that the aircraft FZ1, FZ2, FZ3 to be maintained in the first period of time T1 are located in the provided maintenance time frames, but in particular before the respective deadline 21 for an item of maintenance 20, at a maintenance station WS1.1, WS2.1, WS2.2 adequately equipped for carrying out the maintenance. Whether a maintenance station is adequately equipped for an item of maintenance 10 can be determined on the basis of suitable items of information about the individual maintenance stations WS1.1, WS2.1, WS2.2 with respect to equipment and capacity.

The layover of the aircraft FZ1 at the maintenance station WS1.1 is planned longer in the illustrated exemplary embodiment than necessary for the actually provided maintenance 20, to provide a buffer to be able to immediately solve any problems occurring while the maintenance is carried out at the maintenance station WS1.1.

For the second period of time T2, only the flight plan having the flight routes 10 to be operated (cf. parallel lines) is provided, without it already being specified which of the aircraft FZ1, FZ2, FZ3, FZ4, FZ5 operates the respective flight routes 10. A part of the flight routes 10 is combined to form a rotation 11, by which it is specified for the flight routes 10 of the rotation 11 that these are operated in succession by the same aircraft FZ1, FZ2, FZ3, FZ4, FZ5. The second period of time T2 becomes the new first period of time T1 after corresponding progress of time after completion of the first period of time T1.

For all flight routes 10, diverse technical requirements exist which have to be met by an aircraft FZ1, FZ2, FZ3, FZ4, FZ5, which is to operate the flight route 10. The technical requirements include, for example, the required range and the number of seats. At the same time, suitable items of information are provided for each aircraft FZ1, FZ2, FZ3, FZ4, FZ5, such as range and number of seats, via which it can be established whether an aircraft FZ1, FZ2, FZ3, FZ4, FZ5 can also actually operate a specific flight route 10.

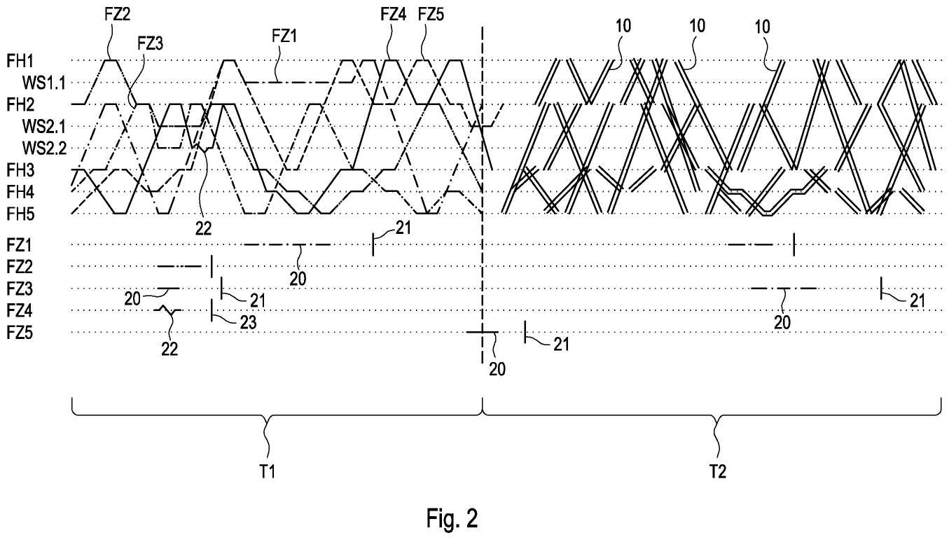

The method according to an aspect of the present disclosure will be explained proceeding from FIG. 1 on the basis of FIGS. 2 and 3a and b.

In a first step, all required items of maintenance work 20 for all aircraft FZ1, FZ2, FZ3, FZ4, FZ5 are determined at least for the first period of time T1. At the same time, in principle the items of required maintenance work 20 for the second period of time T2 can also be determined, wherein these items of information generally only have to be used when the routing is created for the second period of time T2, which is explained later on the basis of FIGS. 3a and b. It is therefore also possible that the required items of maintenance work 20 for the second period of time T2 are also only determined when the routing for this period of time T2 is being created or is already created.

If no difference results from the determined required items of maintenance work 20 for the first period of time T1 from the items of maintenance work 20 already planned in this period of time T1, the routing created for the first period of time T1 according to FIG. 1 can remain unchanged.

However, it is possible that in an aircraft FZ1, FZ2, FZ3, FZ4, FZ5 during the operation within the first period of time T1, an error message occurs on an onboard computer of one of the aircraft FZ1, FZ2, FZ3, FZ4, FZ5 which requires maintenance at short notice.

In FIG. 2, for the aircraft FZ4, such an item of maintenance work 22 required at short notice due to an error message is shown comprising its deadline 23, by which the maintenance has to be completed. It is illustrated by the zigzag line that the item of maintenance work 22 is not an item of maintenance work 20 which can be planned and is predetermined by maintenance intervals.

Since the deadline 23 of this item of maintenance work 22 which has become necessary at short notice is within the first period of time T1, a suitable ground time of the affected aircraft FZ4 is sought, at which the aircraft FZ4 is available at a maintenance station adequately equipped for the required maintenance work 22 along the existing routing of the aircraft FZ4— in this case maintenance station W2.2. Carrying out the maintenance work 22 is then specified accordingly in the routing of the aircraft FZ4, as shown in FIG. 2.

In the determination of the required items of maintenance work 20 for all aircraft FZ1, FZ2, FZ3, FZ4, FZ5— at the latest before the routing for the second period of time T2 is specified—those items of maintenance work 20 are also determined, the deadlines 21 of which are in the second period of time T2.

For the items of maintenance work 20 having deadline 21 in the second period of time T2, required time spans within the second period of time T2 are specified, for which ground times of the affected aircraft FZ1, FZ2, FZ3, FZ4, FZ5 are to be provided at maintenance stations WS1.1, WS2.1, WS2.2 adequately equipped for the required items of maintenance work 20. In the case of the items of maintenance work 20 shown in FIG. 2 having deadline 21 in the second period of time T2, the time spans correspond to the respective items of maintenance work 20. As explained in more detail later in conjunction with FIG. 3b, it is also possible, however, to plan multiple items of maintenance work 20 in a common time span. If specifications are provided as to which items of maintenance work 20 may be executed in parallel if needed, corresponding items of maintenance work 20 can be budgeted in parallel, for example, in the same time span. It is also possible that items of maintenance work 20, the preliminary and finishing work of which—for example the removal and installation of individual components—are identical or similar, are budgeted jointly to thus enhance synergy effects.

If the corresponding time spans are specified, subsequently the routing of all aircraft FZ1, FZ2, FZ3, FZ4, FZ5 in the flight network is specified for the second period of time so that, on the one hand, all flight routes 10 are operated, on the other hand, the aircraft FZ1, FZ2, FZ3, FZ4, FZ5 are planned for the previously determined time spans required for carrying out the items of maintenance work 20 at maintenance stations WS1.1, WS2.1, WS2.2.

In the determination of the routing, the technical data of the aircraft FZ1, FZ2, FZ3, FZ4, FZ5 are compared to the technical requirements of the individual flight routes 10 in such a way that it is ensured that an aircraft FZ1, FZ2, FZ3, FZ4, FZ5 provided for a flight route 10 is technically capable—for example with regard to the passenger capacity and range—of also actually operating the flight route 10.

In the budgeting of the time spans provided for the items of maintenance work 20, it is ensured on the basis of items of information on the items of maintenance work 20 and on the technical equipment of the individual maintenance stations WS1.1, WS2.1, WS2.2 that the items of maintenance work 20 to be carried out within a time span can also actually be carried out at the maintenance station WS1.1, WS2.1, WS2.2 provided for this purpose.

In FIG. 3a, a routing, specified on the basis of the items of maintenance work 20 having deadline in the second period of time 21 and the flight routes 10 to be operated in the second period of time, of the aircraft FZ1, FZ2, FZ3, FZ4, FZ5 is shown, in which sufficient ground times for all required items of maintenance work 20 at maintenance stations WS1.1, WS2.1, WS2.2 equipped for this purpose are provided.

The special feature results here in the routing shown by way of example according to FIG. 3a that the maintenance 20 required for the aircraft FZ1 can exclusively be carried out at the maintenance station WS1.1. Since due to the other boundary condition in the specification of the routing in the routing of the aircraft FZ1, sufficient ground time at the airport FZ1 does not result, before the actual maintenance 20 at the maintenance station WS1.1, a transfer flight from the airport FZ2 to the airport FZ1 is necessary. Since the flight does not represent a flight route 10 to be operated, it can be carried out as an empty flight or it is offered as an additional special flight.

FIG. 3b is fundamentally comparable to FIG. 3a. However, in FIG. 3b, additionally items of maintenance work 22 due to error messages of the onboard computers of the aircraft FZ1 and FZ5 are also to be taken into consideration.

Although the deadline 23 of the maintenance 22 which has become necessary for the aircraft FZ1 is in the second period of time T2, the maintenance 22 can also be carried out in the first period of time T1 together with the maintenance already specified there at the maintenance station WS1.1. On the basis of the items of information about the items of maintenance 20, 22 to be carried out and on the technical equipment of the maintenance station WS1.1, carrying out the maintenance 22 together with the maintenance 20 can be specified, without the ground time previously used for the aircraft FZ1 for carrying out the maintenance work 20 having been exceeded.

Comparably, one of the items of maintenance 22 which have become necessary for the aircraft FZ5 is specified together with a ground time at the maintenance station WS2.1, which is already budgeted for the first period of time T1 but projects into the second period of time T2.

Since this ground time is not also sufficient for carrying out the second of the items of maintenance 22 which has become necessary for the aircraft FZ5, an additional visit to the maintenance station WS2.2 is specified for the aircraft FZ5. Since the aircraft FZ5 does not have sufficient ground time in the routing, as was created without items of maintenance 22 which have additionally become necessary (cf. FIG. 3a), for carrying out the maintenance 22 in question, a routing differing therefrom is specified for the second period of time T2, in which sufficient ground times are provided at an airport FH1, FH2, FH3, FH4, FH5 having an adequately equipped maintenance station WS1.1, WS2.1, WS2.2. In relation to the routing from FIG. 3a, in the routing according to FIG. 3b, several flight routes of the aircraft FZ1 and FZ5 are “switched”. Of course, in this routing, the technical requirements of the individual flight routes 10 and the technical properties of the aircraft FZ1, FZ2, FZ3, FZ4, FZ5 are also taken into consideration.

The items of maintenance 20, 22 specified using the method according to the an aspect of the present disclosure are carried out at the maintenance stations WS1.1, WS2.1, WS2.2 at the times provided for this purpose.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for carrying out items of maintenance work on commercial aircraft of a fleet used in a flight network, wherein:
for each of the aircraft of the fleet:
technical data,
information on required items of maintenance work on the basis of maintenance intervals or error messages comprising deadlines for the completion of the individual items of maintenance work, and
items of information on the provided routing of the aircraft in the flight network in a first period of time comprising the ground times of the aircraft;
for the fleet:
a flight plan for a second period of time following the first period of time, comprising the flight routes of the flight network to be operated having the technical requirements of the individual flight routes; and
for the flight network:
the maintenance stations in the flight network comprising their technical equipment and capacity;
are available, the method comprising:
determining the required items of maintenance work of at least one aircraft of the fleet, the required items comprising the deadlines of the items of maintenance work;
upon determining that the deadline of at least one item of maintenance work of an aircraft falls in the first period of time:
specifying a maintenance station adequately equipped for carrying out the maintenance work in the flight network for carrying out the maintenance work in a specific ground time of the aircraft;
upon determining that the deadline of an item of maintenance work of an aircraft falls in the second period of time:
specifying at least one time span required for carrying out the item(s) of maintenance work on an aircraft within the second period of time, and
specifying the routing of all aircraft in the flight network in consideration of the technical data of the aircraft and the technical requirements of the individual flight routes, wherein the routing for the aircraft to be maintained has a ground time corresponding to the at least one specified time span at a maintenance station adequately equipped for carrying out the maintenance work; and
carrying out the items of maintenance work on an aircraft at the specified maintenance station in the provided ground time.

2. The method as claimed in claim 1, wherein upon determining that the deadline of an item of maintenance work of an aircraft falls in the second period of time, it is checked whether, as the flight plan progresses out of the first period of time, it is possible to carry out the maintenance work at an adequately equipped maintenance station at a planned ground time and, if so, the routing of all aircraft in the flight network is updated for the second period of time until the deadline of the maintenance work from the first period of time.

3. The method as claimed in claim 1, wherein the items of information on required items of maintenance work comprise specifications on which items of maintenance work may technically be executed in parallel.

4. The method as claimed in claim 1, wherein the specification of a maintenance station adequately equipped for carrying out the maintenance work in the first period of time selects that maintenance station, the capacities of which are sufficient for the items of maintenance work in question.

5. The method as claimed in claim 1, wherein upon determining that there is not sufficient capacity of a maintenance station within the first period of time for specifying carrying out an item of maintenance work on an aircraft a deferrable item of maintenance work on another aircraft at the maintenance station is deferred to provide capacities for the items of maintenance work urgently necessary at short notice of the one aircraft.

6. The method as claimed in claim 1, wherein upon specifying carrying out items of maintenance work in the first period of time, further carrying out at least one item of maintenance work, the deadline of which is in the second period of time, is also specified.

7. The method as claimed in claim 1, wherein the technical data of an aircraft comprise specifications of the aircraft type, the jet engine options, the payload mass, or the passenger capacity, divided into individual booking classes, the range, the cruise speed, and/or takeoff and landing requirements.

8. The method as claimed in claim 1, wherein for the required items of maintenance work, items of information on the components of the aircraft affected by the maintenance work or requirements on which aircraft systems are to be temporarily shut down for the maintenance work are available.

9. The method as claimed in claim 1, wherein the technical requirements of the individual flight routes comprise takeoff and landing parameters of the connected airports or the distance between the airports, wherein the takeoff and landing parameters preferably comprise the length or the permissible surface pressure per landing gear wheel of the takeoff or landing runways.

10. The method as claimed in claim 1, wherein the first period of time is up to 21 days.

11. A non-transitory computer readable medium comprising a computer program product comprising program parts which, when loaded in a computer, are designed for carrying out the method as claimed in claim 1.
